(19) United States
(12) Patent Application Publication
(10) Pub. No.: US 2003/0129454 A1
(43) Pub. Date: Jul. 10, 2003

(54) Spin valve magnetoresistive sensor

(75) Inventor: Hidehiko Suzuki, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/323,216

(22) Filed: Dec. 18, 2002

(30) Foreign Application Priority Data
Jan. 8, 2002 (JP) 2002-001748

(51) Int. Cl. B32B 9/00

(52) U.S. Cl. 428/694 EC; 428/692; 428/694 TM

(57) ABSTRACT

A magnetoresistive sensor including a first antiferromagnetic layer, a pinned ferromagnetic layer provided on the first antiferromagnetic layer, a first nonmagnetic conductive layer provided on the pinned ferromagnetic layer, a free ferromagnetic layer provided on the first nonmagnetic conductive layer, and a second nonmagnetic conductive layer provided on the free ferromagnetic layer. The magnetoresistive sensor further includes a specular layer provided on the second nonmagnetic conductive layer, and an interlayer coupling control layer provided on the specular layer. The interlayer coupling control layer is provided by a second antiferromagnetic layer or a hard ferromagnetic layer.

### BACKGROUND OF THE INVENTION

1. Field of the Invention

The present invention relates to a spin valve magnetoresistive sensor and a spin valve magnetoresistive head using the sensor.

2. Description of the Related Art

In association with a reduction in size and an increase in recording density of a magnetic disk drive in recent years, the flying height of a head slider has become smaller and it has been desired to realize the contact recording/reproduction such that the head slider flies a very small height above a recording medium or comes into contact with the recording medium. Further, a conventional magnetic induction head has a disadvantage such that its reproduction output decreases with a decrease in peripheral speed of a magnetic disk as the recording medium (relative speed between the head and the medium) caused by a reduction in diameter of the magnetic disk. To cope with this disadvantage, recently, there has extensively been developed a magnetoresistive head (MR head) whose reproduction output does not depend on the peripheral speed and capable of obtaining a large output even at a low peripheral speed. Such a magnetoresistive head is now a dominating magnetic head. Further, a magnetic head utilizing a giant magnetoresistive (GMR) effect is also commercially available at present.

With higher-density recording in a magnetic disk drive, a recording area of one bit decreases and a magnetic field generated from the medium accordingly becomes smaller. The recording density of a magnetic disk drive currently on the market is about 20 Gbit/in², and it is rising at an annual rate of about 200%. It is therefore desired to develop a magnetoresistive sensor and a magnetoresistive head which can support a minute magnetic field range and can sense a change in small external magnetic field.

At present, a spin valve magnetoresistive sensor utilizing a spin valve GMR effect is widely used in a magnetic head. The spin valve magnetoresistive sensor has a spin valve magnetoresistive film as a multilayer film including a free ferromagnetic layer (free layer) in which the direction of magnetization changes according to an external magnetic field, a nonmagnetic conductive layer formed adjacent to the free layer, a pinned ferromagnetic layer (pinned layer) formed adjacent to the nonmagnetic conductive layer, and an antiferromagnetic layer formed adjacent to the pinned layer for fixing the direction of magnetization in the pinned layer. The antiferromagnetic layer is formed of an antiferromagnetic material.

In the spin valve magnetoresistive film, a relative angle of the direction of magnetization in the free layer to the direction of magnetization in the pinned layer changes to produce a change in resistance. In the case that the direction of magnetization in the free layer is the same as the direction of magnetization in the pinned layer, the resistance becomes a minimum value, whereas in the case that the direction of magnetization in the free layer is opposite to the direction of magnetization in the pinned layer, the resistance becomes a maximum value. In the case of using this magnetoresistive sensor in a magnetic head, the magnetization direction in the pinned layer is fixed to a direction along the height of a magnetoresistive element, and the magnetization direction in the free layer in the condition where no external magnetic field is applied is generally designed to a direction along the width of the magnetoresistive element, which direction is perpendicular to the pinned layer.

Accordingly, the resistance of the spin valve magnetoresistive film can be linearly increased or decreased according to whether the direction of the signal magnetic field from the magnetic recording medium is parallel or antiparallel to the magnetization direction of the pinned layer. Such a linear resistance change facilitates signal processing in the magnetic disk drive. In the magnetoresistive head, a pair of electrode terminals are provided in relation to the magnetoresistive film, and a sense current is passed from the pair of electrode terminals through the magnetoresistive film during operation of the magnetoresistive head.

When the spin valve magnetoresistive head is relatively moved in proximity to a magnetic disk in the condition where the sense current is passed through the magnetoresistive film, the electrical resistance of the magnetoresistive film changes according to a signal magnetic field from the magnetic disk, and a reproduction signal having an output voltage represented as the product of this electrical resistance and the amperage of this sense current is output. The resistivity of the spin valve magnetoresistive film exhibits the response to an external magnetic field as shown in FIG. 1 because of a spin-dependent scattering phenomenon. The output of a reproduction signal by the spin valve magnetoresistive head is substantially proportional to the difference Δρ/t between a maximum value and a minimum value of the sheet resistance changing according to an external magnetic field. This difference Δρ/t will be hereinafter referred to as resistance change Δρ/t.

In general, a spin valve type magnetoresistive film has a large resistance change Δρ/t, so that a spin valve magnetoresistive head having such a spin valve magnetoresistive film generates a high-output reproduction signal. However, it is desired to obtain a higher reproduction output from the spin valve magnetoresistive head by further increasing the resistance change Δρ/t. Various methods have been tried to increase the reproduction output from the spin valve magnetoresistive head. One of these methods is a method of reducing a current flowing without contributing to the spin-dependent scattering phenomenon, i.e., a so-called shunt current, thereby increasing the resistance change Δρ/t.

It is known that the resistance change Δρ/t can be increased by reducing the thicknesses of the free layer and the nonmagnetic conductive layer. The smaller the resistivity of each layer, the larger the shunt current. In general, the nonmagnetic conductive layer of the spin valve magnetoresistive film is formed of Cu, which has a small resistivity. Accordingly, the resistance change Δρ/t can be increased by reducing the thickness of the nonmagnetic conductive layer, and the amount of the shunt current can be suppressed.

However, in the spin valve magnetoresistive film, an interlayer coupling field Hin due to the interlayer coupling of magnetizations is given mainly from the magnetization in the pinned layer to the magnetization in the free layer. This interlayer coupling field Hin increases with a reduction in thickness of the free layer or the nonmagnetic conductive layer. FIG. 2 shows the dependence of Δρ/t and Hin upon the thickness of the Cu nonmagnetic conductive layer. As apparent from FIG. 2, Δρ/t increases monotonically with a reduction in the thickness, and Hin increases rapidly with a reduction in the thickness.

When the interlayer coupling field Hin increases in the spin valve magnetoresistive head, the angle formed between the direction of magnetization in the free layer and the direction of magnetization in the pinned layer does not become 90 degrees as an ideal angle, but largely deviates from the ideal angle. In such a condition of large angular deviation, the resistance of the magnetoresistive film does not linearly respond to a change in signal magnetic field, causing a degradation in symmetry of a reproduction waveform from the spin valve magnetoresistive head with respect to the sign of the signal magnetic field. As the result of this symmetry degradation, the dynamic range of the output voltage on its positive or negative side is reduced to cause a reduction in substantial reproduction output. Thus, an increase in the interlayer coupling field Hin causes a degradation in symmetry of the reproduction waveform. Accordingly, there is a limit to the reduction in thickness of the nonmagnetic conductive layer for the purpose of increasing the resistance change Δρ/t.

### SUMMARY OF THE INVENTION

It is therefore an object of the present invention to provide a magnetoresistive sensor which can suppress the interlayer coupling field Hin given to the free layer.

In accordance with an aspect of the present invention, there is provided a magnetoresistive sensor including a first antiferromagnetic layer; a pinned ferromagnetic layer provided on said first antiferromagnetic layer; a first nonmagnetic conductive layer provided on said pinned ferromagnetic layer; a free ferromagnetic layer provided on said first nonmagnetic conductive layer; a second nonmagnetic conductive layer provided on said free ferromagnetic layer; a specular layer provided on said second nonmagnetic conductive layer; and an interlayer coupling control layer provided on said specular layer.

The interlayer coupling control layer is provided by a second antiferromagnetic layer or a hard ferromagnetic layer. Preferably, the second antiferromagnetic layer is formed of an alloy selected from the group consisting of PdPtMn, PtMn, NiMn, IrMn, FeMn, and NiO. The hard ferromagnetic layer is formed of a material selected from the group consisting of ferromagnetic elements, alloys of the ferromagnetic elements, and oxides of the ferromagnetic elements.

Preferably, the specular layer is formed of an oxide of aluminum (Al). Alternatively, the specular layer may be formed of an oxide of a material selected from the group consisting of iron (Fe), cobalt (Co), nickel (Ni), and tantalum (Ta). Preferably, the specular layer has a thickness of 5 nm or less. Preferably, the first nonmagnetic conductive layer is formed of a material selected from the group consisting of copper and copper alloys, and has a thickness of 2.6 nm or less. The second nonmagnetic conductive layer is formed of a material selected from the group consisting of copper and copper alloys, and has a thickness of 0.5 to 2.0 nm.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a graph showing a p-H curve in a general spin valve magnetoresistive film and the definition of an interlayer coupling field Hin and Δρ/t in this curve;

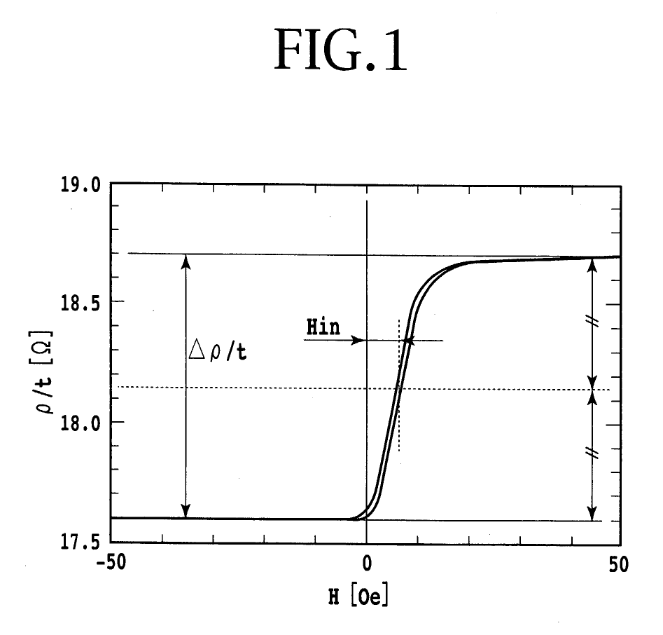

FIG. 2 is a graph showing the dependence of Δρ/t and the interlayer coupling field Hin upon the thickness of a nonmagnetic conductive layer in the spin valve magnetoresistive film;

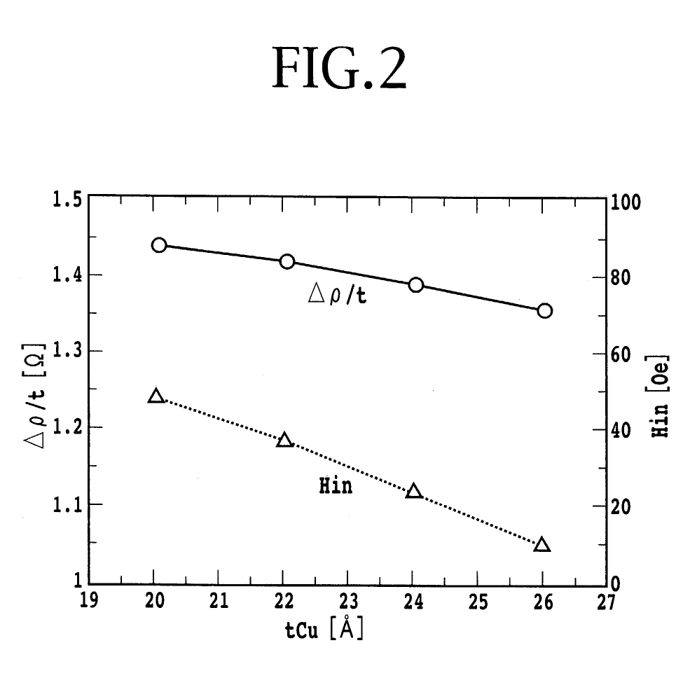

FIG. 3 is a sectional view of a magnetoresistive head to which the magnetoresistive sensor of the present invention is applied;

FIG. 4 is a sectional view of a magnetoresistive sensor according to a first preferred embodiment of the present invention;

FIG. 5 is a graph showing an effect of reducing the interlayer coupling field Hin by an interlayer coupling control layer according to the present invention;

FIG. 6 is a sectional view of a magnetoresistive sensor according to a second preferred embodiment of the present invention;

FIG. 7 is a schematic diagram showing the direction of magnetization in each magnetic layer of the magnetoresistive sensor according to the second preferred embodiment during magnetic annealing; and

FIG. 8 is a view similar to FIG. 7, showing the occurrence of interlayer coupling after annealing.

### DETAILED DESCRIPTION OF THE PREFERRED EMBODIMENTS

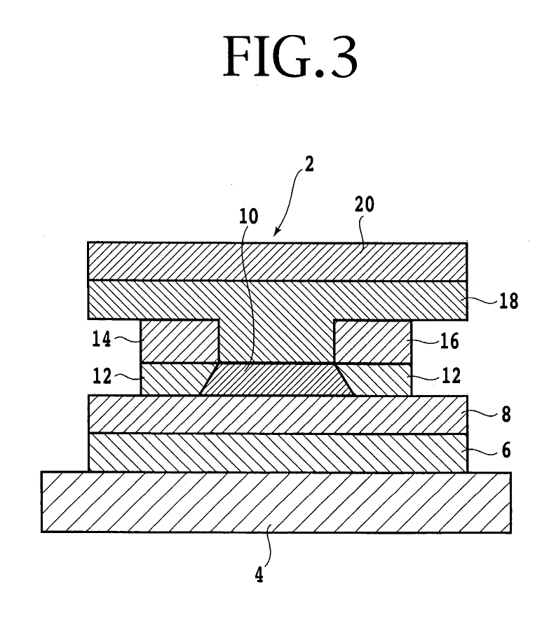

FIG. 3 shows a sectional view of a spin valve magnetoresistive head 2 to which the present invention is applied. The spin valve magnetoresistive head 2 includes a nonmagnetic substrate 4, a lower magnetic shielding layer 6 formed on the nonmagnetic substrate 4, a lower insulating layer 8 formed on the lower magnetic shielding layer 6, and a spin valve magnetoresistive film 10 formed on the lower insulating layer 8. The magnetoresistive head 2 further includes a pair of magnetic domain control films 12 formed on the lower insulating layer 8 so as to sandwich the magnetoresistive film 10 on the opposite sides thereof, a pair of electrodes 14 and 16 formed on the pair of magnetic domain control films 12, respectively, an upper insulating layer 18 formed on the electrodes 14 and 16 and the magnetoresistive film 10, and an upper magnetic shielding layer 20 formed on the upper insulating layer 18.

The substrate 4 is composed of an alumina-titanium carbide (Al₂O₃—TiC) substrate and an Si film or SiO₂ film formed on the Al₂O₃—TiC substrate, for example. The lower magnetic shielding layer 6 and the upper magnetic shielding layer 20 are formed of a soft magnetic material, and function to magnetically shield the magnetoresistive film 10 so as to prevent application of an unwanted external magnetic field to the magnetoresistive film 10. Each of the magnetic shielding layers 6 and 20 is an FeN layer having a thickness of 1.6 μm, for example.

The lower insulating layer 8 and the upper insulating layer 18 are formed of an insulating material, and function to prevent current leakage from the magnetoresistive film 10, the magnetic domain control layer 12, and the electrodes 14 and 16. Each of the insulating layers 8 and 18 is an alumina (Al₂O₃) layer having a thickness of 30 nm, for example. The magnetic domain control layer 12 functions to give a static magnetic field and a magnetic field due to exchange interaction or the like to the magnetoresistive film 10. The magnetic domain control layer 12 is formed of a hard magnetic material such as Co—Pt alloy or Co—Cr—Pt alloy. In the configuration shown in FIG. 3, the magnetic domain control layer 12 has the same thickness as that of the magnetoresistive film 10.

The electrodes 14 and 16 function to apply a sense current through the magnetic domain control layer 12 to the magnetoresistive film 10, and a reproduction signal is extracted from the electrodes 14 and 16. Each of the electrodes 14 and 16 is formed from a conductive film such as a Ta/(Ti—W)/Ta multilayer film composed of an upper Ta layer, a lower Ta layer, and a Ti—W alloy sandwiched between the upper and lower Ta layers.

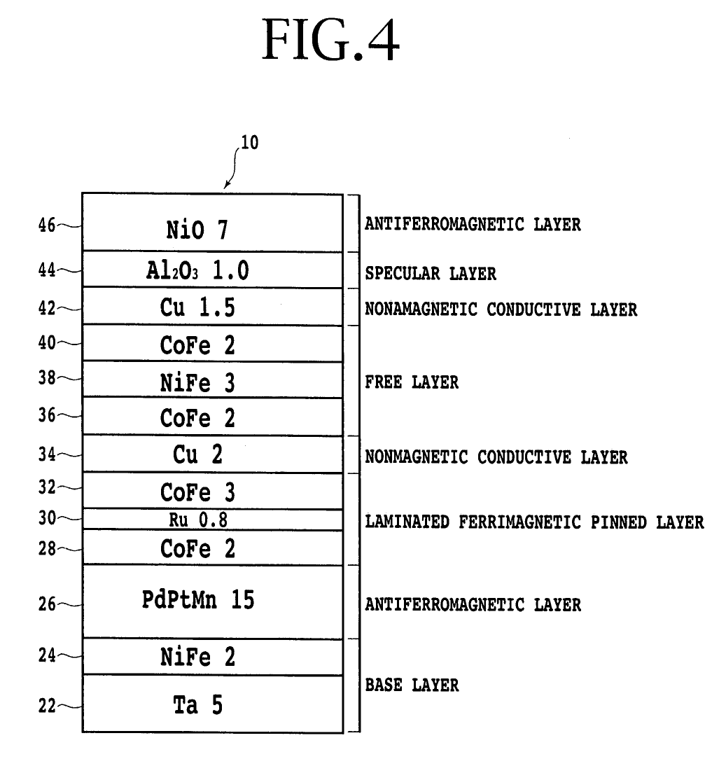

The magnetoresistive film 10 changes its resistance according to a signal magnetic field generating from the magnetization in each one-bit region on a magnetic disk. As mentioned above, a sense current is applied from the electrodes 14 and 16 to the magnetoresistive film 10, so that information carried according to the direction of the magnetization in each one-bit region is extracted as an electrical reproduction signal by the change in resistance of the magnetoresistive film 10. The present invention is characterized by the structure of the magnetoresistive film 10. FIG. 4 shows a sectional view of the spin valve magnetoresistive film or magnetoresistive sensor 10 according to a first preferred embodiment of the present invention.

A 5 nm thick Ta layer 22 is formed by sputter deposition on the lower insulating layer 8 shown in FIG. 3. All of the following layers are also formed by sputter deposition. A 2 nm thick NiFe layer 24 is formed on the Ta layer 22. The Ta layer 22 and the NiFe layer 24 constitute a base layer. A 15 nm thick PdPtMn antiferromagnetic layer 26 is formed on the NiFe layer 24. The antiferromagnetic layer 26 functions to give an interlayer coupling field due to interlayer coupling to a pinned magnetic layer (pinned layer) to be hereinafter described.

A 2 nm thick CoFe layer 28 is formed on the PdPtMn antiferromagnetic layer 26. A 0.8 nm thick Ru layer 30 is formed on the CoFe layer 28, and a 3 nm thick CoFe layer 32 is formed on the Ru layer 30. The Ru layer 30 is an antiparallel coupling intermediate layer for coupling the magnetization in the CoFe layer 28 and the magnetization in the CoFe layer 30 in opposite directions. These layers 28, 30, and 32 constitute a laminated ferrimagnetic pinned layer.

The magnetization in the first CoFe layer 28 of the laminated ferrimagnetic pinned layer is fixed in direction to the same as the magnetization in the antiferromagnetic layer 26 at the interface between the CoFe layer 28 and the antiferromagnetic layer 26 by the interlayer coupling field given from the antiferromagnetic layer 26. On the other hand, the magnetization in the second CoFe layer 32 of the laminated ferrimagnetic pinned layer is fixed in direction opposite to the magnetization in the first CoFe layer 28 by the Ru layer 30.

In general, the magnetization in such a laminated ferrimagnetic pinned layer is small in magnitude, because the two CoFe layers 28 and 32 as soft magnetic layers have magnetizations opposite in direction. When the magnetization is small in magnitude, the magnetization is hardly affected by an external magnetic field and therefore stably pinned. Further, when the magnetization is small in magnitude, a demagnetizing field to this magnetization is also suppressed, so that the disorder of a signal magnetic field from a magnetic disk is also reduced.

A 2 nm thick Cu nonmagnetic conductive layer 34 is formed on the CoFe layer 32. The nonmagnetic conductive layer 34 may be formed of Cu alloys. The nonmagnetic conductive layer 34 functions as a spacer for spacing the laminated ferrimagnetic pinned layer from a free layer to be hereinafter described. A 2 nm thick CoFe layer 36 is formed on the Cu nonmagnetic conductive layer 34. A 3 nm thick NiFe layer 38 is formed on the CoFe layer 36. A 2 nm thick CoFe layer 40 is formed on the NiFe layer 38. These layers 36, 38, and 40 constitute a free ferromagnetic layer (free layer). The magnetization in the free layer rotates in the plane of the free layer according to the magnetic field from the magnetization in each one-bit region on a magnetic disk.

The sheet resistance of the spin valve magnetoresistive film 10 changes according to the angle formed between the rotating magnetization in the free layer and the pinned magnetization in the pinned layer owing to the so-called giant magnetoresistive effect (GMR effect). For example, when these magnetizations are oriented in the same direction, the resistance of the magnetoresistive film 10 becomes a minimum value, whereas when these magnetizations are oriented in the opposite directions, the resistance of the magnetoresistive film 10 becomes a maximum value. The difference between the maximum value and the minimum value is a resistance change Δρ/t. Then, the reproduction signal is output by the application of the sense current according to the above resistance change Δρ/t.

A 1.5 nm thick Cu nonmagnetic conductive layer 42 is formed on the CoFe layer 40. The nonmagnetic conductive layer 42 may be formed of Cu alloys. A 1.0 nm thick Al₂O₃ specular layer 44 is formed on the Cu nonmagnetic conductive layer 42. The specular layer 44 may be formed of an oxide of iron (Fe), cobalt (Co), nickel (Ni), or tantalum (Ta). The specular layer 44 is referred to also as an electron reflecting layer.

A 7 nm thick NiO antiferromagnetic layer 46 is formed on the specular layer 44. The antiferromagnetic layer 46 functions as an interlayer coupling control layer for controlling interlayer coupling between the pinned layer and the free layer. The antiferromagnetic layer 46 functions also as a bias layer for giving a bias magnetic field to the free layer. The material of the antiferromagnetic layer 46 is not limited to NiO, but may be selected from the group consisting of PdPtMn, PtMn, NiMn, IrMn, FeMn, and NiO.

As a modification, the antiferromagnetic layer 46 may be replaced by a hard ferromagnetic layer functioning as an interlayer coupling control layer on the specular layer 44. The hard ferromagnetic layer may be formed of a material selected from ferromagnetic elements such as Fe, Ni, and Co, alloys of the ferromagnetic elements, and oxides of the ferromagnetic elements. The specular layer 44 and the antiferromagnetic layer 46 as an interlayer coupling control layer constitute a cap layer.

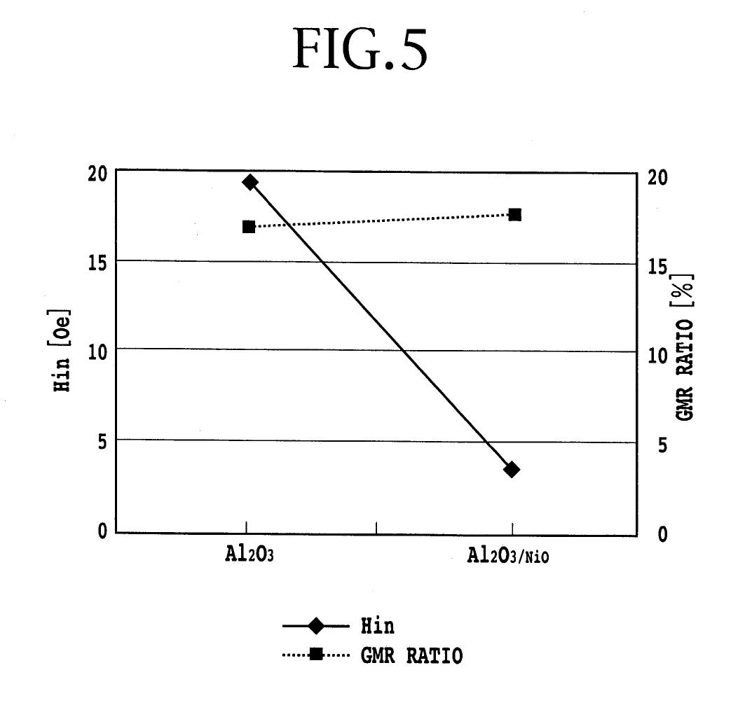

FIG. 5 shows an interlayer coupling field Hin and a GMR ratio in the case where only the Al₂O₃ specular layer 44 is used as the cap layer in the reverse laminated type spin valve magnetoresistive film 10 shown in FIG. 4 and in the case where the Al₂O₃ specular layer 44 and the NiO antiferromagnetic layer 46 are used as the cap layer in the magnetoresistive film 10. As apparent from FIG. 5, by adding the NiO antiferromagnetic layer 46 to the Al₂O₃ specular layer 44 to form the cap layer as in the magnetoresistive film 10 according to the first preferred embodiment, the interlayer coupling field Hin can be reduced by about 16 oersteds (Oe) with the GMR ratio kept substantially constant.

The above result suggests that interlayer coupling occurs between the antiferromagnetic layer 46 as an interlayer coupling control layer and the free layer opposite in direction to the interlayer coupling between the pinned layer and the free layer during magnetic annealing for ordering of the PdPtMn antiferromagnetic layer 26. The interlayer coupling is an effect exhibiting between magnetic layers through conduction electrons. Accordingly, if an oxide layer with no conductivity such as a specular layer is present between upper and lower magnetic layers, no interlayer coupling should occur between the upper and lower magnetic layers. However, since the thickness of the oxide layer used as the specular layer 44 is as very small as 5 nm or less, many defects such as pinholes exist in this layer, and electrons can move through these defects, so that the interlayer coupling is supposed to occur.

In the conventional spin valve magnetoresistive film, an increase in the interlayer coupling field Hin given to the free layer causes a problem especially in the case that the thickness of the Cu nonmagnetic conductive layer 34 is 2.6 nm or less. Accordingly, a reduction in the interlayer coupling field Hin is effective especially in the case that the thickness of the Cu nonmagnetic conductive layer 34 is 2.6 nm or less. Further, the thickness of the Cu nonmagnetic conductive layer 42 is preferably set in the range of 0.5 to 2.0 nm. If the thickness of the layer 42 is greater than 2.0 nm, the interlayer coupling field is too weak, whereas if the thickness of the layer 42 is less than 0.5 nm, the interlayer coupling field is too strong, causing an adverse effect on the magnetization in the free layer.

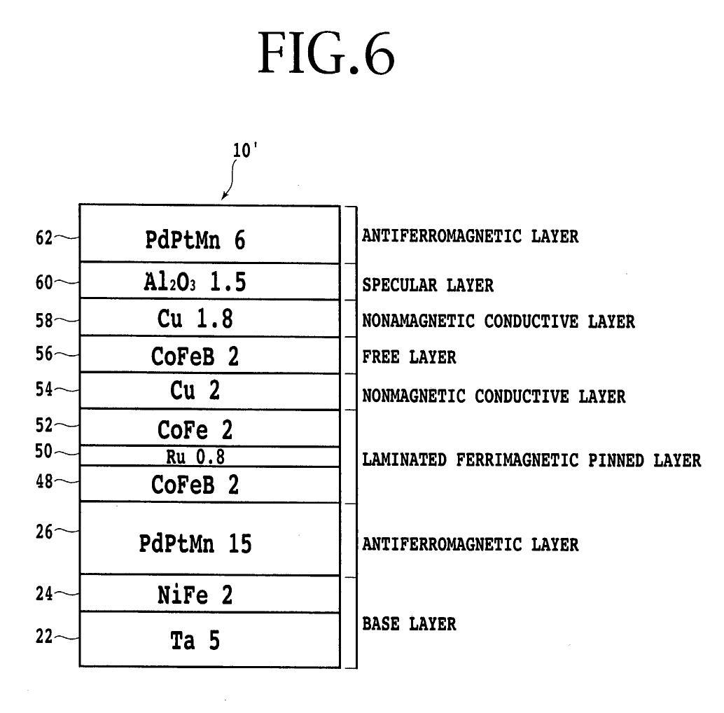

FIG. 6 shows a sectional view of a spin valve magnetoresistive film or spin valve magnetoresistive sensor 10′ according to a second preferred embodiment of the present invention. As in the first preferred embodiment shown in FIG. 4, a 5 nm thick Ta layer 22 and a 2 nm thick NiFe layer 24 are laminated to form a base layer. Further, a 15 nm thick PdPtMn antiferromagnetic layer 26 is formed on the NiFe layer 24. A 2 nm thick CoFeB layer 48 is formed on the antiferromagnetic layer 26. A 0.8 nm thick Ru layer 50 is formed on the CoFeB layer 48. A 2.5 nm thick CoFeB layer 52 is formed on the Ru layer 50. As in the first preferred embodiment, the two CoFeB layers 48 and 52 separated by the Ru layer 50 constitute a laminated ferrimagnetic pinned layer.

A 2 nm thick Cu nonmagnetic conductive layer 54 is formed on the CoFeB layer 52. A 2 nm thick CoFeB free layer 56 is formed on the Cu nonmagnetic conductive layer 54. A 1.8 nm thick Cu nonmagnetic conductive layer 58 is formed on the free layer 56. A 1.5 nm thick Al₂O₃ specular layer or electron reflecting layer 60 is formed on the Cu nonmagnetic conductive layer 58. The specular layer 60 may be formed of an oxide of iron (Fe), cobalt (Co), nickel (Ni), or tantalum (Ta).

A 6 nm thick PdPtMn antiferromagnetic layer 62 as an interlayer coupling control layer is formed on the specular layer 60. As in the first preferred embodiment, the antiferromagnetic layer 62 may be formed of an alloy selected from the group consisting of PdPtMn, PtMn, NiMn, IrMn, FeMn, and NiO. Further, the antiferromagnetic layer 62 may be replaced by a hard ferromagnetic layer formed on the specular layer 60. The hard ferromagnetic layer may be formed of a material selected from ferromagnetic elements such as Fe, Ni, and Co, alloys of the ferromagnetic elements, and oxides of the ferromagnetic elements.

As in the first preferred embodiment, a reduction in interlayer coupling field Hin given to the free layer 56 is effective especially in the case that the thickness of the nonmagnetic conductive layer 54 is 2.6 nm or less. Further, the thickness of the nonmagnetic conductive layer 58 is preferably set in the range of 0.5 to 2.0 nm. Further, the thickness of the specular layer 60 is set preferably to 5 nm or less, more preferably to 2 nm or less, so as to allow the movement of electrons through the defects such as pinholes existing in this layer.

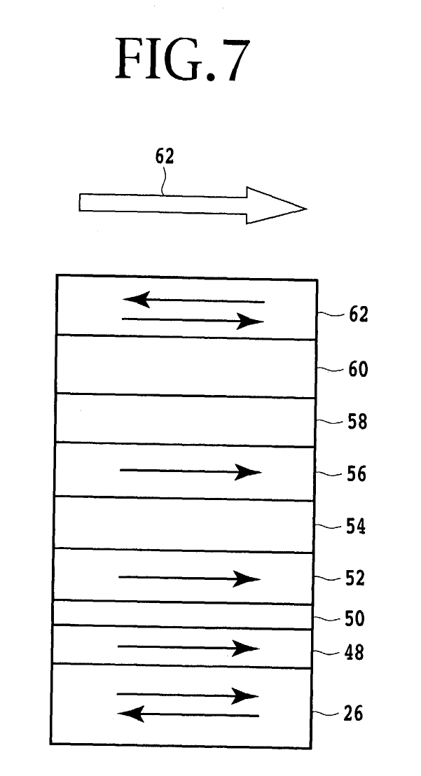

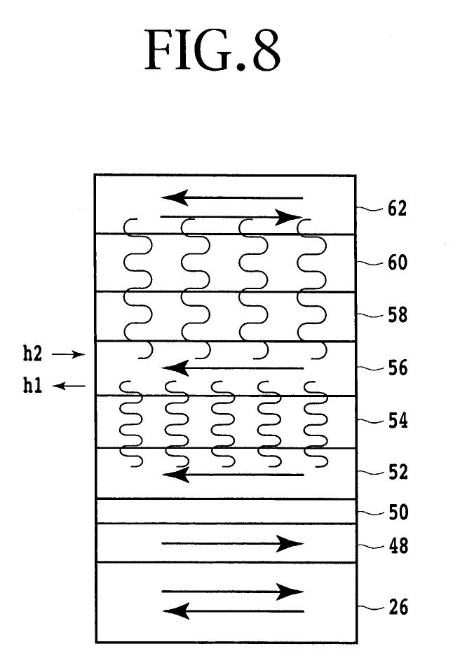

FIG. 7 schematically shows the direction of magnetization in each magnetic layer of the spin valve magnetoresistive film 10′ shown in FIG. 6 during magnetic annealing, and FIG. 8 schematically shows the direction of magnetization in each magnetic layer after annealing. In FIG. 7, arrow 64 denotes the direction of an external magnetic field. As shown in FIG. 7, the directions of magnetizations in the pinned ferromagnetic layers 48 and 52 and in the free ferromagnetic layer 56 are parallel to the direction of the external magnetic field 64 during magnetic annealing. When the temperature of the magnetoresistive film 10′ is lowered to room temperature in the presence of the external magnetic field 64, the direction of magnetization in the pinned ferromagnetic layer 48 is fixed in parallel to the direction of the external magnetic field 64.

When the external magnetic field 64 is then removed, the direction of magnetization in the pinned ferromagnetic layer 52 is fixed in antiparallel to the direction of magnetization in the pinned ferromagnetic layer 48 as shown in FIG. 8, and a leftward interlayer coupling field hi is given from the pinned ferromagnetic layer 52 to the free ferromagnetic layer 56. On the other hand, the direction of magnetization in the antiferromagnetic layer 62 at the interface between this layer 62 and the specular layer 60 is parallel to the direction of the external magnetic field 64 during magnetic annealing, so that a rightward interlayer coupling field h2 is given from the antiferromagnetic layer 62 to the free ferromagnetic layer 56.

As a result, the total interlayer coupling field Hin given to the free ferromagnetic layer 56 becomes hlh2. That is, the total interlayer coupling field Hin becomes smaller than the interlayer coupling field hi given from the pinned ferromagnetic layer 52. In this preferred embodiment, h1>h2, so that the direction of magnetization in the free ferromagnetic layer 56 becomes parallel to the direction of magnetization in the pinned ferromagnetic layer 52. In this preferred embodiment, the thickness of the oxide layer used as the specular layer 60 is as very small as 5 nm or less, so that many defects such as pinholes are present in this layer. Accordingly, electrons can move through the defects in this layer. Thus, although the specular layer 60 with no conductivity is present between the free ferromagnetic layer 56 and the antiferromagnetic layer 62, interlayer coupling is supposed to occur between these layers 56 and 62.

In this preferred embodiment, the total interlayer coupling field Hin given to the free layer 56 is suppressed, and as a result, the deviation in angle formed between the direction of magnetization in the free layer 56 and the direction of magnetization in the pinned layer 52 in relation to the total interlayer coupling field Hin can also be suppressed, thereby improving the linear response of the resistance of the spin valve magnetoresistive film 10′ to a change in signal magnetic field. Accordingly, the magnetoresistive head having such a spin valve magnetoresistive film improved in linear response can obtain a good symmetry in reproduction waveform and a high output.

According to the present invention, the interlayer coupling field Hin given to the free ferromagnetic layer can be suppressed to thereby improve the linear response of the resistance of the magnetoresistive sensor to a change in signal magnetic field. As a result, a good symmetry in reproduction waveform and a high output can be obtained in the magnetoresistive head using this magnetoresistive sensor.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A magnetoresistive sensor comprising:
a first antiferromagnetic layer;
a pinned ferromagnetic layer provided on said first antiferromagnetic layer;
a first nonmagnetic conductive layer provided on said pinned ferromagnetic layer;
a free ferromagnetic layer provided on said first nonmagnetic conductive layer;
a second nonmagnetic conductive layer provided on said free ferromagnetic layer;
a specular layer provided on said second nonmagnetic conductive layer; and
an interlayer coupling control layer provided on said specular layer.

2. A magnetoresistive sensor according to claim 1, wherein said interlayer coupling control layer comprises a second antiferromagnetic layer.

3. A magnetoresistive sensor according to claim 2, wherein said second antiferromagnetic layer is formed of an alloy selected from the group consisting of PdPtMn, PtMn, NiMn, IrMn, FeMn, and NiO.

4. A magnetoresistive sensor according to claim 1, wherein said interlayer coupling control layer comprises a hard ferromagnetic layer.

5. A magnetoresistive sensor according to claim 4, wherein said hard ferromagnetic layer is formed of a material selected from the group consisting of ferromagnetic elements, alloys of said ferromagnetic elements, and oxides of said ferromagnetic elements.

6. A magnetoresistive sensor according to claim 1, wherein said specular layer is formed of an oxide of aluminum (Al).

7. A magnetoresistive sensor according to claim 1, wherein said specular layer is formed of an oxide of a material selected from the group consisting of iron (Fe), cobalt (Co), nickel (Ni), and tantalum (Ta).

8. A magnetoresistive sensor according to claim 1, wherein said specular layer has a thickness of 5 nm or less.

9. A magnetoresistive sensor according to claim 1, wherein said first nonmagnetic conductive layer is formed of a material selected from the group consisting of copper and copper alloys, and has a thickness of 2.6 nm or less.

10. A magnetoresistive sensor according to claim 1, wherein said second nonmagnetic conductive layer is formed of a material selected from the group consisting of copper and copper alloys, and has a thickness of 0.5 to 2.0 nm.
